(19) United States
(12) Patent Application Publication
(10) Pub. No.: US 2004/0078232 A1
(43) Pub. Date: Apr. 22, 2004

(54) System and method for predicting acute, nonspecific health events

(76) Inventor: John S. Troiani, Maple Grove, MN (US)

Correspondence Address: DR. JOHN S. TROIANI, 17767 82nd AVENUE, MAPLE GROVE, MN, 55311, US

(21) Appl. No.: 10/453,672

(22) Filed: Jun. 2, 2003

Related U.S. Application Data
(60) Provisional application No. 60/385,789, filed on Jun. 3, 2002.

(51) Int. Cl. G06F 17/60

(52) U.S. Cl. 705/2

(57) ABSTRACT

A patient monitoring system and method for predicting acute, nonspecific health events uses a statistical random effects model having a linear regression component. The system and method use the model to ascertain trends and/or levels in a patient's health over short periods of time to predict whether an event from a class of acute, nonspecific events has or will onset. The system and method also include a computational system, at least one covariate that is clinically relevant to the class, and data collected from the patient. Preferably, the statistical model is a hierarchical Bayesian model having two stages of prior distributions.

### RELATED APPLICATIONS

This application claims the benefit of U.S. Provisional Application No. 60/385,789, filed on Jun. 3, 2002, hereby incorporated herein in its entirety by reference.

### FEDERALLY SPONSORED RESEARCH AND DEVELOPMENT

The United States Government may have a paid-up license in this invention and a right under limited circumstances to require the patent owner to license to others on reasonable terms, as provided by a grant awarded by the National Institute of Health-National Library of Medicine.

### FIELD OF THE INVENTION

The present invention relates to a system and method for representing a physical condition by mathematical expression to predict whether an unknown event has or will onset. In particular, the present invention relates to a system and method for predicting events from a class of acute, nonspecific health-related events by identifying at least one variable that is clinically relevant to the class, monitoring a patient with respect to the at least one variable, and using data collected from the patient with respect to the at least one variable as input into a statistical model that constructs one or more probability density functions pertaining to the probability that an event has or will onset or that the patient's status has changed.

### BACKGROUND OF THE INVENTION

As computer and digital communications technologies permeate the realm of clinical medicine, such as telemedicine, web-based systems, and electronic medical records, health care providers potentially have at their disposal a wealth of timely, accurate, health-related information. In contrast with the practice of gathering health information only at a point of service, these new information technologies provide a potential to better track the health care status of individual patients and even entire populations in real time. More timely information can lead to earlier detection of problems, more timely therapeutic intervention, and less morbidity. That most of this information is in digital form allows it to be transmitted, copied, and processed faster and more accurately than similar information in human-mediated processes.

This wealth of information, however, does not come without cost. The volume of health data and information available for any given patient or at a health care entity can easily overwhelm human capabilities in an operational clinical environment. Although all the aforementioned data and information is available at any time to gauge patients' health, presently it is typically evaluated only at encounters with a health care provider, and only in limited amounts—a “snapshot”. Thus, large volumes of data potentially conveying important information about patient well-being are simply ignored.

For example, patients with cystic fibrosis often use home monitoring devices to transmit results from self-administered lung function tests and symptom self-reports on a daily basis. Managing the daily volume of data coming into a clinic for multiple such patients may rapidly overwhelm the clinic's staff, who need to identify and attend to more critical clinical responsibilities that require more expertise and judgment than does data review. Consequently, these clinics often review only parts of the data at weekly or less frequent intervals. If these large volumes of data could be reliably screened on a more frequent, predetermined basis by a computer or other computational machine or device, then patients meeting predetermined “risk” thresholds could be timely identified and corresponding actions recommended or taken. Thus, managing health data and information has become an immediate and real concern of health care providers.

Previous efforts to manage health data and information for “disease prediction” in medicine generally can be classified as epidemiologic (population-based predictions of onsets of chronic disease) or event-based. Epidemiologic models typically deliver a risk measure or possibly a point probability estimate that a patient has or will develop an often chronic, pre-specified illness. Their goal is not to predict the onset of acute (magnitudes of hours to days) illnesses, such as bronchitis or pneumonia, but rather chronic illnesses, such as emphysema or diabetes mellitus, taking much longer to develop (magnitudes of several months to years). These models, usually implemented as population-based, classical regression models, require a large body of study subjects and extensive resources for model development and validation. An example of an epidemiologic model is described in Hu et al., U.S. Pat. No. 6,110,109, System and Method for Predicting Disease Onset, in which all the factors used to predict disease are inferred from studies on samples, i.e., none are specific to a given patient.

Predicting onsets of such chronic diseases is problematic, since these diseases onset gradually or remain latent for extended periods of time. When such population-based models are applied to an individual patient, all covariates in the model must be available; otherwise values for the unknown covariates must be imputed, thereby affecting the validity of the output. However, in an operational clinical environment, all covariates usually are not available. Moreover, predictions delivered by these models generally are either point probability estimates or ad hoc risk measures derived from scales based on clinical rules. In short, these epidemiologic models are poorly suited for acute disease or health-related event prediction.

Event-based models generally fall into one of two categories, rule-based models and statistical models. Rule-based models apply a set of clinician-formulated or data-derived rules to no more than a few clinical variables over time to deliver a prediction or classification of “event” or “no event”. While rule-based models may be intuitively appealing, they suffer from a number of deficiencies in predicting acute clinical events. They do not deliver any validatable or verifiable measure of certainty with their predictions. Because of this, the “event”/“no event” output of these algorithms requires resource-intensive human review to get a sense of how likely is an impending event. These models cannot be invoked when input data is missing. Yet, missing and unevenly spaced data is a ubiquitous problem in a real clinical environment. Another weakness of rule-based models is that all patients are assumed to conform to the rules, excluding the possibility of adapting the model to reflect differences between individual patients. Moreover, rule firing thresholds are usually chosen based on clinical judgment or in ad hoc, non-statistical ways, resulting in serious loss of information and degradation of performance; and because the rules invariably rely on averages of time series data, rule-based models blur important trends in the data to meet the rules' input requirements.

Existing statistical models for acute event prediction are few, mostly rudimentary, and fraught with problems. For example, some models employ a t-test or ANOVA (ANalysis Of VAriance) to compare present and past data within a patient's records to detect statistically significant differences in average indicia levels. See Otulana, The Use of Home Spirometry in Detecting Acute Lung Rejection and Infection Following Heart-Lung Transplantation 353-57 (Chest 1990), which describes use of a simple paired t-test. Because these models are based on average levels, trends can be missed. In addition, basic assumptions of these tests, most notably independence and constant variance, may be severely violated in health-related kinds of data. Clinical data invariably exhibits short-term autocorrelation, violating the independence assumption, and variance that increases with mean level, violating the constant variance assumption. Another deficiency is that when data is missing, these tests become ineffective, since their power to detect a significant change accompanying an acute event, if a true difference is present, markedly decreases. These models usually do not use clinical signs or symptoms as additional covariates, and rarely use more than a few clinically relevant measures. Moreover, the simpler models cannot improve their performance since they do not “learn” from new cases, and do not borrow strength from all the available data.

Bayesian models exploit Bayes' formula to calculate the probability of a specified outcome from more easily conceived probabilities and prior knowledge. Fundamentally, Bayes' formula is:

P(event|data)=[P(data|event)·P(event)]/P(data)

where:

P(event|data)=posterior probability of an event, given the available data;

P(data|event)=probability (likelihood) of the data, given an event status;

P(event)=estimated prior (a priori) probability of an event before seeing any data

P(data)=marginal probability of the data

The formula becomes increasingly complex as one uses probability distributions rather than simple point probability estimates and as more variables are added within each term of Bayes' formula.

Bayes' formula provides at least part of the conceptual foundation for intelligent systems such as those described in Baker, U.S. Pat. No. 6,076,083, Diagnostic System Utilizing a Bayesian Network Model Having Link Weights Updated Experimentally; Beverina et al., U.S. Pat. Pub. Nos. 2001/0027388 A1 and 2001/0027389 A1, Method and Apparatus for Risk Management; and Proceedings of the Fourth Annual IEEE Symposium on Computer-Based Medical Systems, pp. 28-35, May 1991. Predictive applications of Bayes' theorem are described in Hoggart et al., U.S. Pat. Pub. No. 2002/0016699 A1, Method and Apparatus for Predicting Whether a Specified Event Will Occur After a Specified Trigger Event Has Occurred; and Smith and West, Monitoring Renal Transplants: An Application of the Multiprocess Kalman Filter 867-78 (Biometrics 1983). Hoggart et al. concerns predicting whether “a specified event will occur for an entity after a specified trigger event has occurred for that entity” [0008]. In short, the nature of the triggering event is known, and the prediction does not concern time series analysis. The Bayesian models of Smith and West consider only data for one patient at a time and therefore do not model random effects between patients, nor do they deliver a probability of an acute event. These models also do not model trend but rather classify changes only from one point to the next.

### SUMMARY OF THE INVENTION

A patient monitoring system and method for predicting acute, nonspecific health events uses a statistical random effects model having a linear regression component. The system and method use the model to ascertain trends and/or levels in a patient's health over short periods of time to predict whether an event from a class of acute, nonspecific events has or will onset. The system and method also include a computational system, at least one covariate that is clinically relevant to the class, and data collected from the patient. Preferably, the statistical model is a hierarchical Bayesian model having two stages of prior distributions.

Preferred embodiments of the present invention predict the onset of events from a class of acute, nonspecific health events based on data collected from a single or multiple patients during a time interval preceding the prediction. Preferred embodiments of the present invention not only provide summary information to health care providers in clinically acceptable form using a few clinically relevant measures, they also provide rich, clinical decision support. Probability measures, such as posterior densities of important parameters in the Bayesian models, are intrinsically more suitable for supporting the types of graded clinical decisions that are made in real clinical environments than is a simple binary prediction of “event” or “no event”.

Three features of preferred embodiments, among others, make the system and method advantageous for patients, health care providers, and others to use. First, data translations are used in creating covariates for the statistical models. For example, use of a variance-stabilizing transformation allows for robust detection of small changes in the lower end of some covariates, where variance decreases with the magnitude of the mean. Second, all the models implement random effects. This feature allows physiologic differences among patients to be considered by the models. For the two stage hierarchical Bayesian models, which assume common distributions from which all random effects are drawn, strength is borrowed from the data of all patients in order to estimate individual effects for each patient. And third, the Bayesian models can make predictions with very little or even no data at all, in which circumstances prior information dominates the prediction. Similarly, these models do not require evenly spaced data.

Preferred embodiments provide robust, significant information because the statistical models used therein rely on sound statistical theory and clinical knowledge, experience, and practice, and collected data has clinical relevance. For example, the preferred embodiment described herein, related to home monitoring of lung transplant recipients, is possible because home spirometry measures have been shown to correlate well with clinically obtained spirometry measures, which are clinically relevant to perceiving episodes of acute bronchopulmonary rejection or infection. In particular, when Bayesian models are used, prior data and information based on clinical experience or studies can be used formally and rigorously in these models to concentrate inferences over physiologically possible ranges. Models without prior distributions, such as classical frequentist models, cannot do this. The robustness of these Bayesian models is further substantiated in that changes in prior probability distributions, even large changes simultaneously in all prior distributions, should not substantially affect predictive performance. Such robust behavior should give health care providers more confidence in making clinical decisions when such decisions are based on or supported by outputs of these models.

Preferred embodiments can implement various kinds of statistical models, including but not limited to classical linear or logistic regression models or combinations of these; classical autoregression models; intelligent systems such as neural networks and Bayesian belief networks; and Bayesian regression and autoregression models, although hierarchical Bayesian random effects linear regression change-point models are preferred. Whereas, wide use of Bayesian models was once impeded by difficulties in computing required marginal posterior distributions, this is no longer so. Iterative Markov Chain Monte Carlo (MCMC) methods such as the Gibbs sampler and Metropolis-Hastings algorithms and others have surmounted many of these difficulties. In specific cases, there may be other methods or even closed form solutions for obtaining desired marginal posterior distributions; however, many situations that were previously inaccessible can be handled using this conceptually simple and general technique.

Consequently, use of Bayesian models can be very appealing in a health care environment. Prior data and information can be formally and rigorously incorporated into these models to strengthen inferences, and they can accommodate the statistical complexity characterizing real clinical problems. Research conducted at the University of Minnesota-Twin Cities, see Troiani and Carlin, Comparison of Bayesian, Classical, and Heuristic Approaches in Identifying Acute Disease Events in Lung Transplant Recipients (unpublished manuscript), found that statistical models, and especially Bayesian models, performed significantly different from chance and better than a typical rule-based algorithm, which performed no better than random chance. The best performing models were the hierarchical Bayesian change-point models.

Preferred embodiments implementing a Bayesian model preferably use a hierarchical Bayesian random effects linear regression change-point model. Preferably, the model is also a hierarchical compound linear regression model having two stages of prior distributions, one on the regression parameters themselves and the other on the prior means and variances of the regression parameters. These models can assess whether a change in trend has occurred and the probability of such occurrence over a given time interval. Thus, segments of a time series during which the health of a patient is improving can be separated from those during which it is worsening, or changes in degree of improving or worsening health can be separated, which information can be displayed to a patient or health care provider. (The time at which the change occurred can also be provided, which can offer valuable insights to clinical researchers studying clinical progression of diseases.) In contrast, simpler techniques such as Bayesian or classical simple linear regressions (without a change-point) fit a single line to collected data, thereby blurring changes or jumps that could indicate an impending event or improvement. Moreover, preferred embodiments using Bayesian models can accommodate small numbers of data points or missing and/or unevenly spaced data, which is not so for several other statistical models. In fact, on small data sets such as in the preferred embodiment (0 to 14 data points per covariate), many statisticians feel that Bayesian models excel because they take advantage of prior information and because the asymptotic assumptions of classical statistics may break down.

In addition to the advantages previously mentioned, preferred embodiments implementing Bayesian random effects linear regression models in an MCMC framework provide the following advantages: they can accommodate almost arbitrary probabilistic complexity and are very flexible, they allow prior data and information to be formally incorporated into the models; they allow straightforward imputation of missing values, they deliver posterior probabilities of events based on observed data, and not on as or more extreme unseen data; they treat subjects individually through subject specific random effects, a crucial feature; and they can use all available data and information from all presented cases to maximize their learning potential about individual cases. Moreover, these preferred embodiments can continue to learn by further systematic training of the models with new data and information, until performance is optimized.

Along with predicting an event or nonevent, Bayesian random effects linear regression models can deliver estimates of the means and variances of all model parameters for each patient, including regression coefficients such as slope; the distributions from which the parameters were drawn; and missing Y and X values. Of most interest is the posterior probability of an event, given the data, as well as the slope or jump after a change-point, the change-point, and their posterior probabilities, given the data. The classical models deliver point estimates of the slope, intercepts, and variance for each patient as well as other model parameters such as event status.

Preferred methods for predicting whether an acute, nonspecific health event has or will onset in a patient comprise providing a computational system having both input and output devices for communicating to and from the computational system, respectively; defining a class of acute, nonspecific events; implementing in the computational system a statistical random effects model having a linear regression component, for predicting an onset of an event from the defined class of events; employing the computational system to construct at least one probability density function and deliver at least a probability with respect to whether an event from the defined class of events has or will onset; and communicating information delivered by the computational system and related to the predicting.

Some preferred embodiments of patient monitoring systems each comprise a statistical random effects model having a linear regression component and using at least one indicia covariate that is clinically relevant to the class; and a computational system to implement the statistical model to construct at least one probability density function and deliver at least a probability with respect to whether an event from the class of events has or will onset. The patient monitoring system may further comprise at least one time series of data related to the at least one indicia covariate and collected from the patient during a time interval preceding the predicting, to be utilized by the computational system in a process related to the predicting.

Alternatively, these preferred embodiments each may be viewed as a computer program for executing a computer process for predicting whether an event from a class of acute, nonspecific health events has or will onset in a patient, the computer program being storage medium readable by a computing system or embedded in a microprocessor. The computer process comprises implementing a statistical random effects model having a linear regression component and using at least one indicia covariate that is clinically relevant to the class; accepting at least one time series of data related to the at least one indicia covariate and collected from the patient during a time interval preceding the predicting; constructing a probability density function with respect to an occurrence of a change-point within the time interval; and utilizing the statistical model and the at least one time series of data to construct at least one other probability density function and deliver at least a probability with respect to whether an event from the class of events has or will onset.

Other preferred embodiments of patient monitoring systems each comprise a Bayesian random effects model having a linear regression component and using at least one indicia covariate that is clinically relevant to the class; at least one time series of data related to the at least one indicia covariate and collected from the patient during a time interval preceding the predicting; and a computational system to implement the Bayesian model and utilize the at least one time series of data to construct at least one probability density function and deliver at least a probability with respect to whether an event from the class of events has or will onset.

### BRIEF DESCRIPTION OF THE FIGURES

FIG. 1 is a pictorial overview of the present invention.

FIG. 2 is a diagram illustrating the methodology for implementing a statistical model of the present invention.

FIG. 3 is a composite of various trend patterns generalized between “event” and “no event”.

FIGS. 4A and 4B are diagrams of the statistical model of the preferred embodiment showing the two stages of prior distributions.

### DETAILED DESCRIPTION OF THE PREFERRED EMBODIMENT

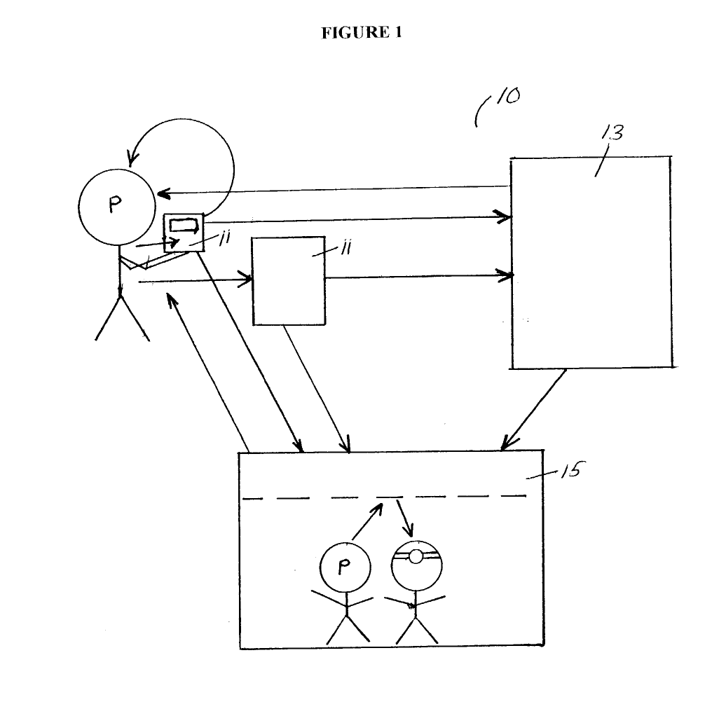

Preferred embodiments relate to a patient monitoring system and method for predicting acute, nonspecific health events in accordance with the present invention. Preferred embodiments can be implemented in several different environments to reduce patient morbidity and mortality as well as health care costs and utilization. For example, as shown in FIG. 1, the monitoring system 10 can be implemented in devices 11 used by patients at sites remote from health care centers, such as devices used by home-monitoring patients; at data collection facilities 13 off-site of or away from health care treatment facilities of health care centers; and by health care providers or patients at treatment facilities 15 to process data collected about patients during patient contacts and the like.

The preferred embodiment of the present invention is described herein through the use of an example relating to assessing the presence of acute bronchopulmonary disease events in lung transplant recipients. Researchers and health care providers have found that home spirometry and certain other recorded symptoms correlate well with office-measured data, so that data collected at remote sites with respect to these variables may be useful or clinically relevant for making event predictions. As those skilled in the art should be aware, embodiments of the present invention may be used to monitor the progress of other kinds of health and non-health related cases or matters.

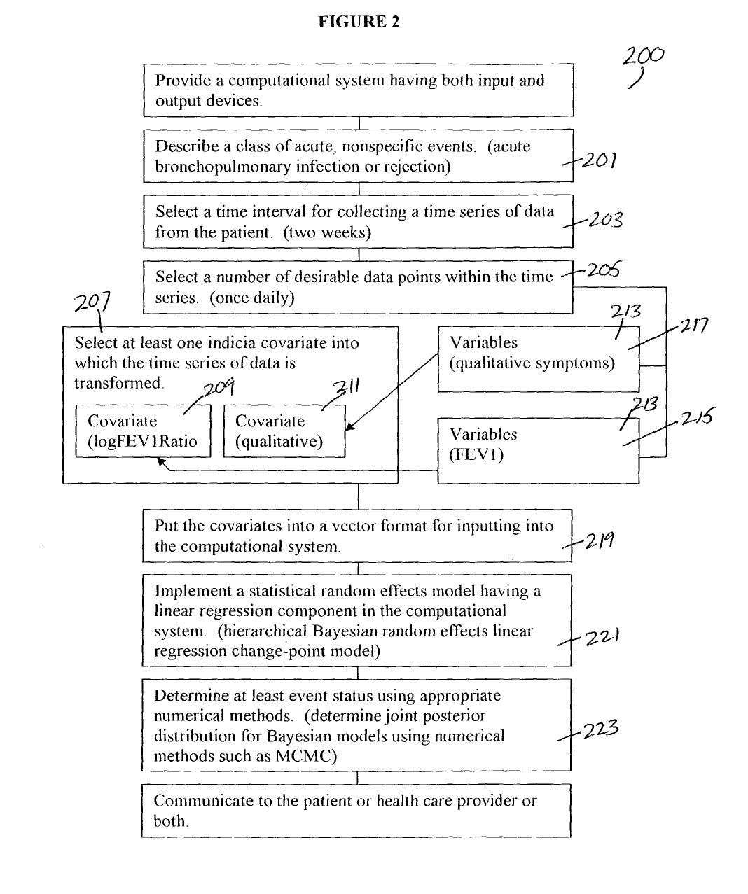

FIG. 2 is a diagram illustrating the methodology for implementing a statistical model 200 of the monitoring system (with notations about the preferred embodiment in parentheses). Predicted events are members of a class of acute, nonspecific events defined by a particular health or disease insult 201. For example, in the lung transplant example, an episode of acute bronchopulmonary rejection or infection is the insult. What actually causes the insult may be unknown and may be any of a number of reasons. Moreover, it may not be known exactly when a given patient's physiologic insult occurs. Nevertheless, the statistical models can deliver a probability density function for an “event” for a given case, and/or a probability cutoff can be defined above (below) which the case is classified as an “event” (“no event”).

A time interval over which a time series of data is collected from a patient 203 and the number of desirable data points within a time series 205 are selected. The lung transplant example uses a two-week time interval, which is considered long enough to allow an acute physiologic deterioration or decline in pulmonary health to be detected, yet short enough to minimize contamination by outliers, past trends, and noise that could affect predictions. Up to 14 daily data points within each time series for each covariate are provided. Those skilled in the art should be aware that the length of a time interval can vary, consistent with the above mentioned concerns and depending on the health matter and other factors, as well as can the number of desirable data points within a time series.

Indicia covariates 207 of the monitoring system may be selected based on clinical knowledge and experience alone. The Bayesian models used in several preferred embodiments are robust to weak predictors and allow stronger covariates to naturally dominate predictions. Preferably, the smallest set of indicia covariates 207 that can be used to optimally predict events is selected, to avoid over-parameterization of the monitoring system. The preferred embodiment uses FEV1 measurements 215 (forced expiratory volume in 1 second obtained by blowing forcefully into a flow meter) and patient qualitative symptoms 217 as indicia variables 213 to construct, respectively, two indicia covariates 207, a transformed FEV1 covariate 209 and a transformed qualitative covariate 211. Using clinical knowledge and experience, the six qualitative symptoms 217 selected are cough, sputum amount, sputum color, wheeze, dyspnea at rest, and wellbeing, which are scored on integer scales from 0 to 3, with the exception of sputum color which is scored on a scale of 0 to 4. The indicia covariates 207 are used for inputting the indicia variables 213 into the statistical models.

In particular, two transformations are applied to FEV1 measurements 215. First, FEV1 measurements 215 for a patient are standardized by dividing each by the maximal predicted FEV1 for the patient, obtained in the first post-op year. Second, each ratio is variance-stabilized, as is often done in time series analysis, by taking the logarithm of the ratio. The respective covariate 209 is referred to as logFEV1Ratio, or Y. By making the variance more nearly uniform at all mean levels, this stabilizing transformation allows for a simpler variance structure (constant), as is usually assumed in regression models.

The six qualitative symptoms 217, or fewer if fewer were available, are recorded daily and combined into a single qualitative covariate 211, X, an arithmetic average of these bronchopulmonary symptoms. The available qualitative symptoms 217 are combined to minimize the number of indicia covariates 207 and parameters in the monitoring system's statistical model and take advantage of at least some degree of asymptotic normality guaranteed by the Central Limit Theorem. The arithmetic average also reduces the variance of the qualitative covariates 211 so that they can be modeled using a single, probability density function.

The covariates for each day within a time series are used to construct a vector 219, which also includes an element for event status (event=1; nonevent=0). These vectors are used for inputting (transformed) data collected from patients into the monitoring system's statistical model. For example, the lung transplant predictive model uses a vector having at least 29 elements, one for each of the daily Y covariates, one for each of the daily X covariates, and the event status. If the event status is known, the vector can then be used to train the model. Those skilled in the art should be aware that additional indicia variables and covariates specific to individual patients, such as age, gender, underlying diagnosis, time since transplant, or any other clinically relevant variable or covariate, may be added to a preferred embodiment to enhance its predictive performance.

Because a change in trend or level may occur at any time in a time series, to reconcile clinical experience and cognitive concepts of events and nonevents with the mathematical structure of a model, preferred embodiments seek to summarize the data with a mean structure consisting of either a single line segment or two adjoining or disjoint line segments separated at most at a single change-point. Implementing models that can calculate change-points is preferred. This is the point in time at which a trend or level of an indicia covariate (and related transformed indicia variables) changes, and thus the first and second parts of the time interval can have different line segment fits. Therefore, a compound linear structure forms the basis for the mean structure of many of the models described herein in the same way that a single line segment forms the basis for the mean structure of a simple linear regression. By modeling the mean structure in this way, as a nonstationary-time series with at most two different adjacent trends or levels in time, the statistical models can eliminate enough variance in physiologic variables to determine whether a short-term decline in clinical status is likely, and thus whether an existing or impending acute, nonspecific event is likely.

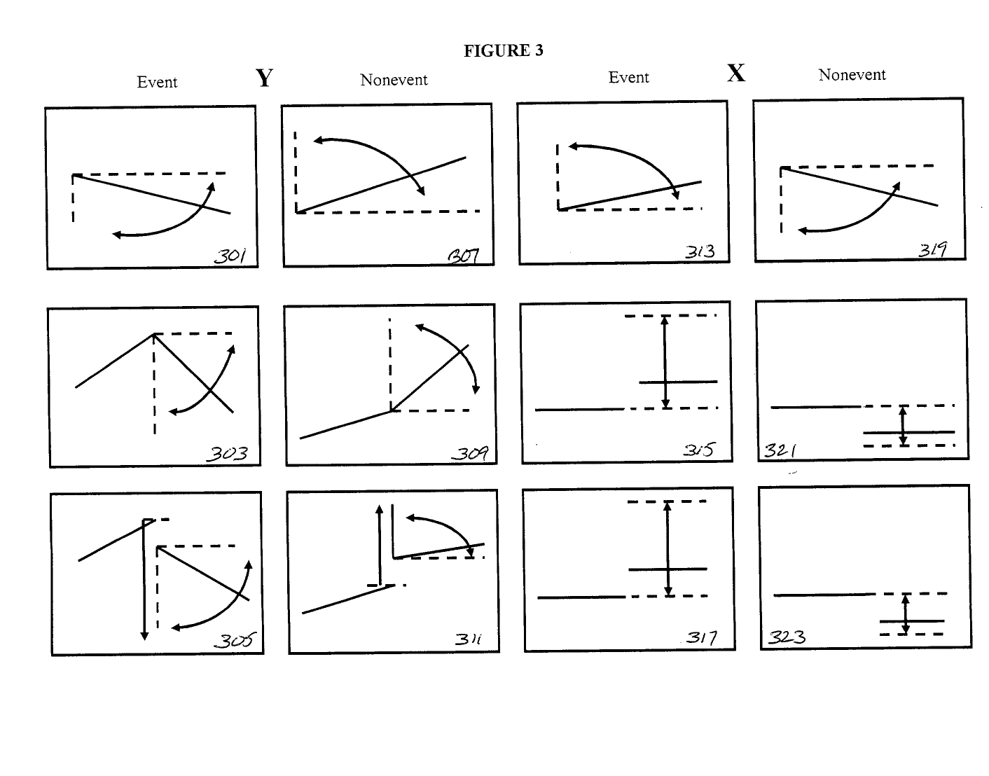

FIG. 3 illustrates examples of slopes 301, 303, and 305 for Y generalized as events and slopes 307, 309, and 311 generalized as nonevents. For X, jumps 313, 315, and 317 are generalized as events, and jumps 319, 321, and 323 are generalized as nonevents. For spirometry, if the line fit to the second part of the time interval is decreasing, then an event is probable. The steeper the drop, the more likely is an event. Thus, a time series generalized as “event” might initially show improving pulmonary status, but then abruptly change to a worsening status sometime before the time series ends. Had a change-point not been allowed, then a single line segment would have to be fit over the entire time series regardless of a clear change in status. For symptom variables, an increase in average level indicates an event—the greater the increase, the more likely an event.

In constructing the statistical models specified below 221, Yᵢⱼ refers to logFEV1Ratio and Xᵢⱼ refers to the qualitative covariate on day i in time series j. The likelihood distributions of Y and X are each assumed to be Gaussian. The Bayesian change-point models implement a unique compound linear mean structure with a change-point for all Y and for all X in a time series, and with a variance common to all Y and a variance common to all X in the time series. First stage and final stage broad prior exponential distributions are placed on these variances, one for Y and one for X, as in classical regression. First stage prior Gaussian distributions are also paced on each random effect regression parameter, including the change-point. Single second stage priors, based on clinical knowledge and experience, are placed on the means (Gaussian) and variances (exponential) of the first stage prior Gaussian distributions. Classical models do not use such priors, and therefore generate inferences based on the entire real number line for means and the positive real number line for variances.

For Bayesian models, one of the probabilities being sought is the following:

P(E_{unknown}|Eₜᵣₐᵢₙ, Yₜᵣₐᵢₙ, Xₜᵣₐᵢₙ, Y_{unknown}, X_{unknown}).

The term “unknown” refers to a time series of data where the event status is unknown, and “train” refers to a time series where the event status is known. For a hierarchical Bayesian model having two stages of prior distributions, and two levels of parameter vectors θ₁ and θ₂, this probability is calculated as follows:

=∫∫P(θ₁, θ₂, E_{unknown}|Eₜᵣₐᵢₙ, Yₜᵣₐᵢₙ, Xₜᵣₐᵢₙ, Y_{unknown}, X_{unknown})·dθ₁·dθ₂

=[∫∫P(Eₜᵣₐᵢₙ, Yₜᵣₐᵢₙ, Xₜᵣₐᵢₙ, Y_{unknown}, X_{unknown}|θ₁, θ₂, E_{unknown})·P(θ₁|θ₂, E_{unknown})

·P(θ₂|E_{unknown})·P(E_{unknown})·dθ₁·dθ₂]/P(Eₜᵣₐᵢₙ, Yₜᵣₐᵢₙ, Xₜᵣₐᵢₙ, Y_{unknown}, X_{unknown}).

This is a random effects model, where the first stage parameter vector θ₁ is a vector of parameters that are specific to each time series of data for each patient. The vector includes the means and variances of regression parameters and change-points for each covariate, such as Y and X for the lung transplant example. The second stage parameter vector θ₂ is a vector of (hyper-)parameters characterizing the distributions from which the random effects are drawn and includes distributions of the means and variances of the first stage distributions' means and variances.

The following notation is used to describe the statistical models:

<a>⁰=1 for a>=0, and 0 otherwise; and <a>¹=a for a>=0, and 0 otherwise;

i=day number;

j=time series number;

l=unit column vector;

k_{Yj}=change-point for covariate Y in the j^{th} time series;

k_{Xj}=change-point for covariate X in the j^{th} time series;

Eⱼ=event status of j^{th} time series: Eⱼ=0 for a nonevent, and Eⱼ=1 for an event;

Z˜N(μ, σ²) means, “Z is a normal random variable with mean μ and variance σ²”,

Z˜Exp(λ) means, “Z is an exponential random variable with mean λ”;

Z˜Ber(θ) means, “Z is a Bernoulli random variable with event probability θ”;

Z˜U(r, s) means, “Z is distributed continuously and uniformly between r and s”;

Z˜G(r, s) means, “Z is distributed as a gamma variate with mean rs and variance rs²”; and

Z˜D(p_{Y}) is the discrete probability distribution that places vector p_{Y} of probabilities on the elements of vector Z, where ∥p_{Y}^{T}1∥=1.

The parameters and assumed distributions specification for the preferred embodiment, which implements a hierarchical Bayesian random effects linear regression change-point model, are as follows:

| | |
|---|---|
| Yᵢⱼ\|a₁ⱼ, a₂ⱼ, a₃ⱼ, σ_{Y}² | ˜N(a₁ⱼ + i · a₂ⱼ + a₃ⱼ<i − k_{Yj}>¹, σ_{Y}²) |
| Xᵢⱼ\|b₁ⱼ, b₂ⱼ, σ_{X}² | ˜N(b₁ⱼ + b₂ⱼ<i − k_{Xj}>⁰, σ_{X}²) |
| a₁ⱼ\|μₐ₁, Γₐ₁² | ˜N(μₐ₁, Γₐ₁²) |
| a₂ⱼ\|μₐ₂, Γₐ₂² | ˜N(μₐ₂, Γₐ₂²) |
| a₃ⱼ\|μₐ₃, Γₐ₃², Eⱼ | ˜N(μₐ₃ · Eⱼ, Γₐ₃²) |
| b₁ⱼ\|μ_{b1}, Γ_{b1}², Eⱼ | ˜N(μ_{b1} · Eⱼ, Γ_{b1}²) |
| b₂ⱼ\|μ_{b2}, Γ_{b2}², Eⱼ | ˜N(μ_{b2} · Eⱼ, Γ_{b2}²) |
| k_{Yj}\|p_{Y} | ˜D(p_{Y}), where p_{Y}^{T} = (1/14, . . . , 1/14) |
| k_{Xj}\|p_{X} | ˜D(p_{X}), where p_{X}^{T} = (1/14, . . . , 1/14) |
| 1/σ_{Y}² | ˜Exp(10,000) |
| 1/σ_{X}² | ˜Exp(1) |
| μₐ₁ | ˜N(−0.5, 0.25) |
| 1/Γₐ₁² | ˜Exp(1) |
| μₐ₂ | ˜N(0, 0.04) |
| 1/Γₐ₂² | ˜Exp(10,000) |
| μₐ₃ | ˜N(−0.1, 0.04) |
| 1/Γₐ₃² | ˜Exp(10,000) |
| μ_{b1} | ˜N(2, 1) |
| 1/Γ_{b1}² | ˜Exp(1) |
| μ_{b2} | ˜N(0.5, 1) |
| 1/Γ_{b2}² | ˜Exp(1) |
| Eⱼ | ˜Ber(0.1) |

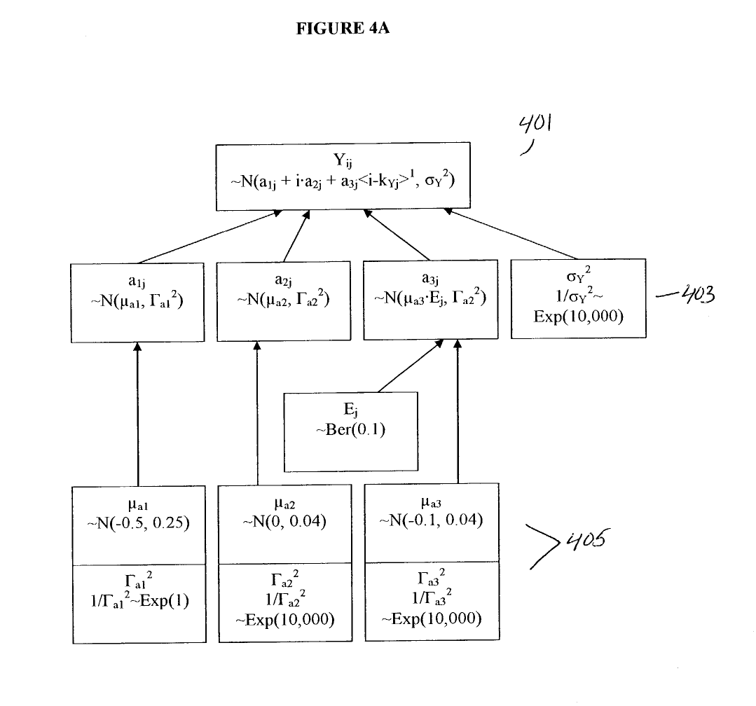

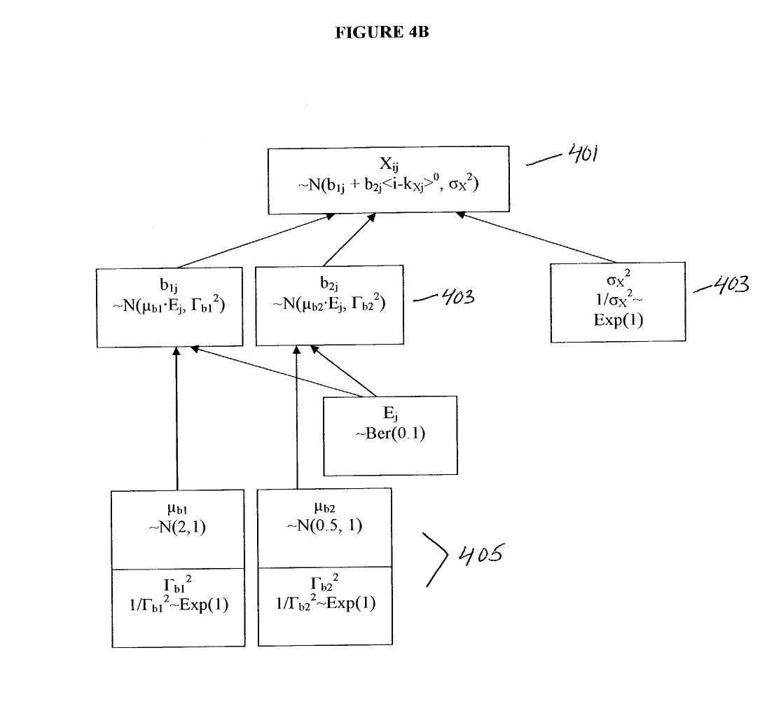

As shown in FIGS. 4A and B, this hierarchical linear regression model 401 has two stages of prior distributions, one on the regression parameters themselves (a, b, and σ²) 403 and the other on the first stage prior means and variances of the regression parameters (μ and Γ²) 305.

Broken-line trajectories induced by this model for typical Y and X time series are depicted in frames 303 and 309, and 315 and 321, of FIG. 3, respectfully. Frames 303 and 309 depict a two-segment compound linear regression for Y, whose segments intersect at a common change-point (i=k_{Yj}) but differ in slope. As depicted in frames 315 and 321, for clinical reasons, a single discrete random jump in level is allowed for X (not a trend) at the change-point (i=k_{Xj}). For each segment of the X time series on either side of the change-point, a slope in symptoms X is less clinically realistic and less statistically meaningful, since significant variation in X from day to day is still expected despite the averaging transformation. This model delivers a single probability of an event Eⱼ for a time series j of an as yet unknown event status, based on both Yⱼ and X_{j.}

Alternative embodiments implementing other Bayesian linear regression models include use of a Bayesian simple linear regression model with the following likelihoods,

| | |
|---|---|
| Yᵢⱼ\|a₁ⱼ, a₂ⱼ, σ_{Y}² | ˜N(a₁ⱼ + i · a₂ⱼ, σ_{Y}²) |
| Xᵢⱼ\|b₁ⱼ, b₂ⱼ, σ_{X}² | ˜N(b₁ⱼ + i · b₂ⱼ, σ_{X}²); |

a Bayesian random effects linear regression change-point model having two stages of prior distributions and allowing for a discrete random jump in Y with the following likelihoods,

| | |
|---|---|
| Yᵢⱼ\|a₁ⱼ, a₂ⱼ, a₃ⱼ, a₄ⱼ, | ˜N(a₁ⱼ + i · a₂ⱼ + a₃ⱼ<i − k_{Yj}>¹ + a₄ⱼ<i − k_{Yj}>⁰, σ_{Y}²) |
| σ_{Y}² | |
| Xᵢⱼ\|b₁ⱼ, b₂ⱼ, σ_{X}² | ˜N(b₁ⱼ + b₂ⱼ<i − k_{Xj}>⁰, σ_{X}²), |

and a Bayesian simple linear regression first-order autoregression model with the following likelihoods,

| | |
|---|---|
| Yᵢⱼ\|a₁ⱼ, a₂ⱼ, σ_{Y}² | ˜N(a₁ⱼ + i · a₂ + ρ_{Y}[Y_{i - 1,j} − a₁ⱼ − (i − 1)a₂ⱼ], σ_{Y}²) |
| Xᵢⱼ\|b₁ⱼ, b₂ⱼ, σ_{X}² | ˜N(b₁ⱼ + i · b₂ⱼ + ρ_{X}[X_{i - 1,j} − b₁ⱼ − (i − 1)b₂ⱼ], σ_{X}²). |

This last model adds a first-order autocorrelation term to the mean structure of the Y and X likelihoods to account for the possibility that some autocorrelation in the data might not be considered by a multi-stage hierarchical structure. All first stage priors and second stage priors are identical to those of the Bayesian simple linear regression model, with the addition of uninformative ρ_{Y}˜U(−1,1) and ρ_{X}˜U(−1,1). Those skilled in the art should be aware that there are yet other possible model variations.

Given only available data, the Bayesian models are capable of delivering a posterior probability of an event in a new, previously unseen time series of data for a new or previously seen patient and the probability that the patient is worsening. For the preferred embodiment, this means that the monitored or indicia variables are worsening, causing a positive jump in qualitative symptoms and/or a decreasing terminal slope for spirometry. These models can also deliver a probability that the patient has experienced any significant change in clinical status, defined as a change in trend or level, and the most likely time that a change in clinical status occurred, if any.

In operation, the preferred embodiment attempts to fit the available logFEV1Ratios of a time series with two different lines, one before a change-point and one after the change-point. The linear fits represent best fits to otherwise randomly fluctuating data and are fit by a probability model, not explicitly by ordinary least squares as is usually done in linear regression. These models assume that the time series can be divided into at most two parts, which may differ in length, as the change-point, a priori, is assumed to favor no day between the first and last. An analogous process is attempted for the available qualitative covariates in the time series.

Bayesian models are first trained and tested on data with known event status, and then used for cases where the event status is unknown. The Bayesian models can be implemented using MCMC methods to compute joint posterior distributions 223. In MCMC methods, the joint posterior distribution is determined using Bayes' rule, usually as a complex multivariate algebraic expression. The joint posterior distribution for the preferred embodiment is given below in short-hand distributional notation. Expressions in parentheses are conditional probability distributions of the variable to the left of the vertical bar conditioned on those to the right. Subscripted, single Greek parameters not in parentheses represent (hyper-)prior distributions and not variables themselves.

parameters|data ∝{

$$parameters \vert data ∝ \{ {∐}_{j = 1}^{N} {F}_{j} {G}_{j} \} {μ}_{{a}_{1}} {μ}_{{a}_{2}} {μ}_{{a}_{3}} {μ}_{{b}_{1}} {μ}_{{b}_{2}} {Γ}_{{a}_{1}} {Γ}_{{a}_{2}} {Γ}_{{a}_{3}} {Γ}_{{b}_{1}} {Γ}_{{b}_{2}} {σ}_{X} {σ}_{Y}$$

FⱼGⱼ}μₐ_{₁}μₐ_{₂}μₐ_{₃}μ_{b}_{₁}μ_{b}_{₂}Γₐ_{₁}Γₐ_{₂}Γₐ_{₃}Γ_{b}_{₁}Γ_{b}_{₂}σ_{X}σ_{Y}

where the first stage likelihood (Fⱼ) and second stage priors on the regression coefficients (Gⱼ) for the j^{th} subject's time series are given as follows:

$${F}_{j} = {∐}_{i = 1}^{14} ( {Y}_{ij} \vert {a}_{1 j} , {a}_{2 j} , {a}_{3 j} , {k}_{Yj} , {σ}_{Y} ) ( {X}_{ij} \vert {b}_{1 j} , {b}_{2 j} , {k}_{Xj} , {σ}_{X} )$$

Gⱼ=(a₁ⱼ|μₐ_{₁}, Γₐ_{₁})(a₂ⱼ|μₐ_{₂}, Γₐ_{₂})(a₃ⱼ|μₐ_{₃}, Eⱼ, Γₐ_{₃})(b ₁ⱼ|μ_{b}_{₁}, Eⱼ, Γ_{b}_{₁})(b₂_{ⱼ}|μ_{b}_{₂}, Eⱼ, Γ_{b}_{₂})(Eⱼ)k_{Y}_{ⱼ}k_{X}_{ⱼ}

Next, an algebraic expression for the full conditional probability distribution for each and every parameter, including Eⱼ and the change-point k, and missing data values in the model is constructed by assuming all other parameters except that of interest are constant. A random value for each parameter and missing data value is generated from each full conditional distribution using any number of standard pseudorandom number sampling algorithms. These resulting random values are then substituted back into all full conditional distributions to derive a new set of distributions (of the same form) from which a second set of random numbers are generated. These new numbers are substituted back into the full conditionals to derive yet a another set of distributions. At convergence (minimal autocorrelation between sequential values for each parameter), the resulting values for all parameters and missing data values approximate their values obtained from their marginal posterior distributions. Thus, a histogram of the sequential values for each parameter, upon acceptable convergence, is an estimate of the marginal posterior distribution for that parameter, i.e., the full posterior distribution with all other parameters and missing data values integrated out to leave only the remaining parameter of interest. The following equations are some of the full conditional distributions characterizing the preferred embodiment of the Bayesian models.

For Eⱼ:

$$\begin{matrix}{E}_{j} \vert {μ}_{a3} , {μ}_{b1} , {μ}_{b2} , {τ}_{a3}^{2} , {τ}_{b1}^{2} , {τ}_{b2}^{2} , {a}_{3 j} , {b}_{1 j} , {b}_{2 j} , {θ}_{0} ∼ Ber ( \frac{{θ}_{0} {Ω}_{j}}{1 + {θ}_{0} ( {Ω}_{j} - 1 )} ) \\ {Ω}_{j} = {ⅇ}^{- ( 1 / 2 ) [ {μ}_{a3} \frac{( {μ}_{a3} - 2 {a}_{3 j} )}{{τ}_{a3}^{2}} + {μ}_{b1} \frac{( {μ}_{b1} - 2 {b}_{1 j} )}{{τ}_{b1}^{2}} + {μ}_{b2} \frac{( {μ}_{b2} - 2 {b}_{2 j} )}{{τ}_{b2}^{2}} ]}\end{matrix}$$

For the Y-precision, (1/σ_{Y}²), where C is a normalizing constant:

$$( 1 / {σ}_{Y}^{2} ) \vert data , N , {a}_{1} , {a}_{2} , {a}_{3} , {k}_{Y} = C * {\prod }_{j = 1}^{N} \{ {( 1 / {σ}_{Y} )}^{14} {ⅇ}^{- ( 1 / 2 {σ}_{Y}^{2} ) {\sum }_{i = 1}^{14} {( {y}_{ij} - {a}_{1 j} - {a}_{2 j} i - {a}_{3 j} < i - {k}_{Yj} {>}^{1} )}^{2}} \} {ⅇ}^{- 1 / ( {10}^{4} {σ}_{Y}^{2} )} = C * {( 1 / {σ}_{Y}^{2} )}^{7 N} {ⅇ}^{- ( 1 / 2 {σ}_{Y}^{2} ) \{ [ {\sum }_{j = 1}^{N} {\sum }_{i = 1}^{14} {( {y}_{ij} - {a}_{1 j} - {a}_{2 j} i - {a}_{3 j} < i - {k}_{Yj} {>}^{1} )}^{2} ] - 2 * {10}^{- 4} \}} \\ ( 1 / {σ}_{Y}^{2} ) \vert data , N , {a}_{1 j} , {a}_{2 j} , {a}_{3 j} , {k}_{Y} ∼ G ( 7 N + 1 , 2 / \{ [ {\sum }_{j = 1}^{N} {\sum }_{i = 1}^{14} {( {y}_{ij} - {a}_{1 j} - {a}_{2 j} i - {a}_{3 j} < i - {k}_{Yj} {>}^{1} )}^{2} ] - 2 * {10}^{- 4} \} )$$

For the X-precision, (1/σ_{X}²), where C is a normalizing constant:

$$( 1 / {σ}_{X}^{2} ) \vert data , N , {b}_{1} , {b}_{2} , {k}_{X} = C * {\prod }_{j = 1}^{N} \{ {( 1 / {σ}_{X} )}^{14} {ⅇ}^{- ( 1 / 2 {σ}_{X}^{2} ) {\sum }_{i = 1}^{14} {( {x}_{ij} - {b}_{1 j} - {b}_{2 j} < i - {k}_{Xj} {>}^{0} )}^{2}} \} {ⅇ}^{- 1 / ( {σ}_{X}^{2} )} = C * {( 1 / {σ}_{X}^{2} )}^{7 N} {ⅇ}^{- ( 1 / 2 {σ}_{X}^{2} ) \{ [ {\sum }_{j = 1}^{N} {\sum }_{i = 1}^{14} {( {x}_{ij} - {b}_{1 j} - {b}_{2 j} < i - {k}_{Xj} {>}^{0} )}^{2} ] - 2 \}} \\ ( 1 / {σ}_{X}^{2} ) \vert data , N , {b}_{1} , {b}_{2} , {k}_{X} ∼ G ( 7 N + 1 , 2 / \{ [ {\sum }_{j = 1}^{N} {\sum }_{i = 1}^{14} {( {x}_{ij} - {b}_{1 j} - {b}_{2 j} < i - {k}_{Xj} {>}^{0} )}^{2} ] - 2 \} )$$

For the jump in symptoms at the change-point, b₂ⱼ:

$${b}_{2 j} \vert {σ}_{X}^{2} , {x}_{j}^{ϖ} , {b}_{1 j} , {k}_{Xj} , {τ}_{b2}^{2} , {μ}_{b2} , {E}_{j} ∝ {ⅇ}^{- ( 1 / 2 {σ}_{X}^{2} ) {\sum }_{i = 1}^{14} {( {x}_{ij} - {b}_{1 j} - {b}_{2 j} < i - {k}_{Xj} {>}^{0} )}^{2}} {ⅇ}^{- ( 1 / 2 {τ}_{b2}^{2} ) {( {b}_{2 j} - {μ}_{b2} {E}_{j} )}^{2}}$$

This is a normal distribution, since it is quadratic in the exponent. Algebraic manipulation yields the following full conditional for b₂ⱼ:

$${b}_{2 j} \vert {σ}_{X}^{2} , {x}_{j}^{ϖ} , {b}_{1 j} , {k}_{Xj} , {τ}_{b2}^{2} , {μ}_{b2} , {E}_{j} ∼ N ( B * \{ ( {\sum }_{i = 1}^{14} ( {x}_{ij} - {b}_{1 j} ) {I}_{i \geq {k}_{Xj}} ( i ) ] + \frac{{σ}_{X}^{2}}{{τ}_{b2}^{2}} {μ}_{b2} {E}_{j} \} , B {σ}_{X}^{2} ) , \\ where \\ B = \frac{{τ}_{b2}^{2}}{{τ}_{b2}^{2} {\sum }_{i = 1}^{14} {I}_{i \geq {k}_{Xj}} ( i ) + {σ}_{X}^{2}} = \frac{{τ}_{b2}^{2}}{{τ}_{b2}^{2} ( 15 - {k}_{Xj} ) + {σ}_{X}^{2}}$$

and I_{i>=k} (i) is the indicator function, where I(i)=1 when i>=k, and I(i)=0 otherwise.

These four distributions are the full conditional distributions of the event status (Eⱼ), the precisions for Y and X (1/Γ_{Y}² and 1/Γ_{X}², respectively), and the jump in X (b₂ⱼ). Other parameters can be constructed in analogous fashion in accordance with Bayesian and general statistical concepts. As new cases become available, and their event status known, the Bayesian models can be further trained for optimal predicting performance.

The parameters and assumed distributions specification for preferred embodiments using a classical logistic regression model are as follows:

| | |
|---|---|
| Yᵢⱼ\|a₁ⱼ, a₂ⱼ, σ_{Y}² | ˜N(a₁ⱼ + i · a₂ⱼ, σ_{Y}²) |
| Xᵢⱼ\|b₁ⱼ, b₂ⱼ, σ_{X}² | ˜N(b₁ⱼ + i · b₂ⱼ, σ_{X}²) |
| Eⱼ | ˜Ber(pⱼ) |

logit(pⱼ)=any combination ofβ₁+β₂·a_{2j*+β}₃·b₁*+β₄·b_{2j*+all two way interactions and quadratic terms,}

where superscript “*” indicates ordinary least squares estimates that can also be obtained by maximizing the specified Y and X likelihoods above.

The classical models deliver an estimate of the probability of an event for a new case and a single point estimate (maximal likelihood or other) of the change-point. In this particular embodiment, a simple linear regression is equivalent to standard ordinary least squares parameter estimation, which is performed on each time series for each patient to obtain the estimates a₂ⱼ*, b₁ⱼ*, and b₂ⱼ* of the corresponding regression parameters (a₂ⱼ, b₁ⱼ, and b₂ⱼ), resulting in one set of estimates per time series. With the estimated regression parameters for each training case as covariates and the event status of each training case as the response variable, the logistic regression on the training cases delivers the logistic coefficients β₁, β₂, β₃, and β₄ and other terms. These coefficients can then be used to deliver a point probability estimate of an impending event in a new time series j, using the calculated ordinary least squares intercepts and slopes for Yⱼ and Xⱼ as inputs into the following standard logistic probability equation:

P(Eⱼ)=exp{ logit(pⱼ)/[1+exp(logit(pⱼ))]},

where

logit(pⱼ)=any combination of β₁+β₂·a₂ⱼ* +β₃·b₁ⱼ* +β₄·b₂ⱼ* +all two way interactions and quadratic terms.

As new cases become available, and their event status known, the logistic coefficient estimates can be updated to reflect the greater information available.

As those skilled in the art are aware, there are a wide variety of ways for communicating patient data and information and other data and information into, out of, and throughout the patient monitoring system. The system uses a computational system to implement a statistical model and utilize any available time series of data for a patient to calculate the above described probability distributions, covariate and parameter statistical summaries, probabilities, and the like. The models may be implemented either as software or in hardware such as a microprocessor. Data and information may be input in various forms, such as explicitly, in the form of a sample to be analyzed, and the like, using any of numerous devices intended for that purpose. Information may be communicated to patients, health care providers, or other authorized persons, including statistical model output, recommendations regarding contact between the patient and the health care provider, and the like, using any of numerous devices intended for that purpose. Parts of the system may include hand held devices for patients or health care providers or both, at least one database in which to store any information delivered or communicated using the patient monitoring system, and communication connections via the Internet or other networks including telephony, via mail, and the like.

Although the preferred embodiment and various alternative embodiments of the patient monitoring system have been described herein, it should be recognized that numerous changes and variations can be made to these embodiments that are still within the spirit of the present invention. The scope of the present invention is to be defined by the claims.

That which is claimed:

1. A method for predicting whether an acute, nonspecific health event has or will onset in a patient, the method comprising:
providing a computational system having both input and output devices for communicating to and from the computational system, respectively;
defining a class of acute, nonspecific events;
selecting a time interval for collecting a time series of data from the patient;
selecting at least one indicia covariate into which the time series of data is transformed for inputting into the computational system;
implementing in the computational system a Bayesian random effects model having a linear regression component, for predicting an onset of an event from the defined class of events;
employing the computational system to construct at least one probability density function and deliver at least a probability with respect to whether an event from the defined class of events has or will onset; and
communicating to the patient or a health care provider or both information delivered by the computational system and related to the predicting.

2. The method of claim 1, further comprising the step of constructing a probability density function with respect to an occurrence of a change-point within the time interval, so that a broken-line trajectory can be induced on available data in the time series.

3. The method of claim 1, wherein the step of implementing the Bayesian model includes implementing two stages of prior distributions for the model, wherein the second stage prior distributions are based on clinical knowledge and experience.

4. The method of claim 1, wherein the step of selecting at least one indicia covariate selects a covariate based at least partially on that indicia variable which most dominates the predicting.

5. The method of claim 1, wherein the step of defining a class of acute, nonspecific events defines events related to acute bronchopulmonary infection or rejection, and the step of selecting at least one indicia covariate selects a covariate based at least partially on FEV1.

6. The method of claim 1, wherein the step of defining a class of acute, nonspecific events defines events related to acute bronchopulmonary infection or rejection, and the step of selecting at least one indicia covariate selects a covariate based at least partially on an indicia variable for at least one of cough, sputum amount, sputum color, wheeze, dyspnea at rest, and well-being.

7. The method of claim 1, wherein the step of selecting at least one indicia covariate selects a variance-stabilized covariate.

8. The method of claim 1, further including the step of training the Bayesian model for optimal predicting performance.

9. A method for predicting whether an acute, nonspecific health event has or will onset in a patient, the method comprising:
providing a computational system having both input and output devices for communicating to and from the computational system, respectively;
defining a class of acute, nonspecific events;
implementing in the computational system a statistical random effects model having a linear regression component, for predicting an onset of an event from the defined class of events;
employing the computational system to construct at least one probability density function and deliver at least a probability with respect to whether an event from the defined class of events has or will onset; and
communicating information delivered by the computational system and related to the predicting.

10. The method of claim 9, further comprising the steps of selecting a time interval for collecting a time series of data from the patient, selecting a number of desirable data points within the time series, and selecting at least one indicia covariate into which the time series of data is transformed for inputting into the computational system.

11. A patient monitoring system for predicting whether an event from a class of acute, nonspecific health events has or will onset in a patient, the system comprising:
a Bayesian random effects model having a linear regression component and using at least one indicia covariate that is clinically relevant to the class;
at least one time series of data related to the at least one indicia covariate and collected from the patient during a time interval preceding the predicting; and
a computational system to implement the Bayesian model and utilize the at least one time series of data to construct at least one probability density function and deliver at least a probability with respect to whether an event from the class of events has or will onset.

12. The patient monitoring system of claim 11, wherein the Bayesian model constructs a probability density function with respect to an occurrence of a change-point within the time interval.

13. The patient monitoring system of claim 11, wherein the Bayesian model is a hierarchical model having two stages of prior distributions, wherein the second stage prior distributions are based on clinical knowledge and experience.

14. The patient monitoring system of claim 11, wherein one indicia covariate is based at least partially on that indicia variable which most dominates the predicting.

15. The patient monitoring system of claim 11, wherein the at least one indicia covariate is a set of covariates selected in part based on clinical knowledge and experience.

16. The patient monitoring system of claim 11, wherein an indicia covariate is based at least partially on FEV1.

17. The patient monitoring system of claim 11, wherein the patient monitoring system monitors lung transplant recipients for acute bronchopulmonary rejection or infection, and the at least one indicia covariate is based at least partially on an indicia variable for at least one of cough, sputum amount, sputum color, wheeze, dyspnea at rest, and well-being.

18. The patient monitoring system of claim 11, wherein an indicia covariate is variance-stabilized.

19. The patient monitoring system of claim 11, further comprising a communication system to communicate to the patient or a health care provider or both information delivered by the computational system and related to the predicting.

20. The patient monitoring system of claim 11, further comprising a database wherein at least some information delivered by the computational system is stored.

21. A patient monitoring system for predicting whether an event from a class of acute, nonspecific health events has or will onset in a patient, the system comprising:
a statistical random effects model having a linear regression component and using at least one indicia covariate that is clinically relevant to the class; and
a computational system to implement the statistical model to construct at least one probability density function and deliver at least a probability with respect to whether an event from the class of events has or will onset.

22. The patient monitoring system of claim 21, further comprising at least one time series of data related to the at least one indicia covariate and collected from the patient during a time interval preceding the predicting, wherein the time series of data is utilized by the computational system in a process related to the predicting.

23. A computer program for executing a computer process for predicting whether an event from a class of acute, nonspecific health events has or will onset in a patient, the computer program being storage medium readable by a computing system or embedded in a microprocessor, the computer process comprising:
implementing a statistical random effects model having a linear regression component and using at least one indicia covariate that is clinically relevant to the class;
accepting at least one time series of data related to the at least one indicia covariate and collected from the patient during a time interval preceding the predicting;
constructing a probability density function with respect to an occurrence of a change-point within the time interval; and
utilizing the statistical model and the at least one time series of data to construct at least one other probability density function and deliver at least a probability with respect to whether an event from the class of events has or will onset.

24. The computer program of claim 23, wherein the statistical model is a Bayesian random effects linear regression model.

25. A patient monitoring system for predicting whether an event from a class of acute, nonspecific health events has or will onset in a patient, the system comprising:
a statistical means using at least one indicia covariate that is clinically relevant to the class;
at least one time series of data related to the at least one indicia covariate and collected from the patient during a time interval preceding the predicting; and
a computational means for implementing the statistical means and utilizing the at least one time series of data to construct at least one probability density function and deliver at least a probability with respect to whether an event from the class of events has or will onset.
